(19) United States
(12) Patent Application Publication
(10) Pub. No.: US 2019/0362440 A1
(43) Pub. Date: Nov. 28, 2019

(54) VETTER BECAUSE FRIENDS MAKE DATING BETTER

(71) Applicants: Megan Williams, Philadelphia, PA (US); Margaret Barclay Cunningham, Erdenheim, PA (US)

(72) Inventors: Megan Williams, Philadelphia, PA (US); Margaret Barclay Cunningham, Erdenheim, PA (US)

(21) Appl. No.: 16/420,102

(22) Filed: May 22, 2019

Related U.S. Application Data
(60) Provisional application No. 62/674,890, filed on May 22, 2018.

(51) Int. Cl. G06Q 50/00; H04L 29/08

(52) U.S. Cl. CPC G06Q 50/01; H04L 67/306

(57) ABSTRACT

The aim of the disclosed dating method and mobile dating application for use on mobile devices is to have clients meet their significant others online through their friends. The disclosed app allows a vetter, a trusted friend of the client, to vet potential dating candidates and communicate with them prior to the candidate and the client being introduced by the vetter. Additionally, unique filters created by both the client and the vetter can be used to filter candidates.

### CROSS REFERENCE TO RELATED APPLICATION

This application claims the benefit of U.S. Provisional Patent Application Ser. No. 62/674,890 filed May 22, 2018, which is incorporated by reference as if fully set forth.

### BRIEF DESCRIPTION OF DRAWINGS

FIG. 1 is a flow diagram of the interactions between a trusted advisor (i.e. the “vetter”), the candidate, and the friend as described herein.

FIG. 2 is a block diagram of a computer system designed to carry out the dating application described herein, according to one embodiment.

### DETAILED DESCRIPTION

The dating marketspace has proven to be big business and continues to expand, with one in three dates in the United States beginning online. Jefferies reports that today's global market of 500 million people will reach 672 million people by 2019 (Winkler).

The disclosed method and mobile app enters this ever-expanding marketplace with a new model for online dating specifically targeted at the 29+ crowd. In the place of today's numerous behavioral and compatibility dating platforms, The disclosed method and mobile app is founded on the belief that the “social network effect” is a key determinant in helping individuals find satisfying relationships. In keeping with empirical research in psychology, the disclosed method and mobile app is based on the idea that the support of our friends and families is one of the best predictors of a relationship's success or failure (Slotter). By asking the client to choose a “vetter”—one or more of his or her best friends or family members who will create customized search filters for prospective dates and “moderate” interactions, the disclosed method and mobile app mobilizes the most powerful of all screening tools: our friends. We all know the enormous extent to which we rely on our friends when dating, yet this knowledge has yet to appear in technological form. The disclosed method and mobile app realizes the matchmaking potential of our friends in the form of a customized lifestyle app that puts the social back into dating. It believes that out friends know us better than computer algorithms ever can.

Initially aimed at the professional woman for whom the dating stakes are higher than they were when she was in her early twenties, the disclosed method and mobile app acknowledges the untapped potential for online dating to cross the generational digital divide. The Pew Research Center reports that not only has the share of 18 to 24-year-olds who use online dating tripled between 2013 and 2016, but online dating has doubled in the 55 to 64-year-old age bracket, with 12% reporting using an online dating site or mobile app versus 6% in 2013 (Smith). The disclosed method and mobile app offers an individual customized control over their dating selection process instead of relying solely on computer algorithms and online questionnaires. It appeals to the person who wants to be introduced to prospective dates through a network of friends, but who understands the realities of today's global marketplace: if a best friend lives in Chicago and a brother lives in Tokyo, this triangulated introduction can only occur through the disclosed method and mobile app, and current dating apps fail in this regard.

While the initial targeted demographic of the disclosed method and mobile app is women of any sexual orientation, the disclosed method and mobile app is also designed to appeal directly to the confident man—to the man who wants “her friends to like him” and who doesn't mind a little healthy competition with other men for attention. The disclosed method and mobile app targeted man is tired of hook-up sites; he wants depth in addition to visual swiping.

Above all else, the disclosed method and mobile app is a service that is universal in its appeal; the fact that your friends know you better than anyone else is a truth that transcends age, gender, and sexual orientation.

In today's dating world, you no longer date a person; you date a profile. Each dating profile you peruse gets tossed around in conversations, over emails, in quick peeks at screen shots between best friends at the gym. 22% of online daters ask friends to help them create their profile, with one in three women asking for help, while 16% of men turn to their friends (Thottam). Local restaurant owners report that their regulars frequently hand their phones over at the bar to “swipe left or right.” The disclosed method and mobile app takes this daily vetting process and implements it within a lifestyle app.

The disclosed method and mobile app monetizes the fact that one's best chance at finding love these days is through a friend, with 63% of married couples saying this is how they were introduced. In comparison, online statistics show that 20% of people in current long-term relationships met online, while 7% of marriages in 2015 were between people who met online (Thottam). The aim of the disclosed method and mobile app is to capitalize on these statistics and to make their vectors intersect: to have clients meet their significant others online through their friends.

These statistics support the insights that a woman relies on her friends for dating support. Her friends know her better than anyone. They've been with her through every blubbering breakup, through every heartbreaking attempt to get full custody. In fact, if she had a dollar for every time one of them has consoled her by saying, “I told you so” or “why didn't you listen to me?” she'd be rich. Most of the client's friends are in committed relationships, but they love to talk about her dating life, frequently sighing that their lives “are so boring” compared to hers.

Men and women venturing out into the dating world, perhaps after a long hiatus due to marriage and then a nasty divorce and custody battle, are looking for confirmation. More than anything, they have an established social network and they want their BFFs to like their boyfriend or girlfriend. They want their friends and family to be invested in the process; to share accountability so that, hopefully, down the line, they can actually sit down for a half-pleasant dinner together.

At the same time, meeting someone in today's world can be profoundly isolating; more often than not, a woman or man is sitting alone, staring at the screen, swiping through profiles. The days of meeting someone at a bar, at the local laundromat, or at a running race, surrounded by the protective buzzing of friends (and the threat of their sting), have faded into the past. The disclosed method and mobile app takes the loneliness and anxiety out of the online dating process by making it a communal activity. With the disclosed method and mobile app, dating becomes a social activity again—a simulacrum of the experience of two friends sitting at a bar where one leans over to tell the other, “I have someone I'd love to set you up with.” By bringing a third party into the dating game, the disclosed method and mobile app makes the dating journey fun and enjoyable again.

The men and women who need the disclosed method and mobile app have families, demanding careers. More importantly, they understand that they keep making the same mistakes in their love lives. They need, in essence, a dating Board of Directors, a collection of close friends and advisors, vetters, whose shared skillset is their in-depth knowledge of the client as person.

The targeted female understands that life is not a popularity contest. She would rather meet one good date after looking through a hundred profiles than meet seven dates in a week. Time is of a premium for the client and her community of friends. While she has an endless collection of “waiting minutes”—in the grocery line, in the elevator, on the treadmill, at the doctor's office—when she can examine profiles selected by her friends, but she is proprietary of her weekends and evenings. In general, her life is good. If she is going to give up a weekend or an evening to meet with a date, she wants to do everything in her power to make it a good meeting. She wants her date to be vetted.

The disclosed method and mobile app capitalizes on the built-in voyeurism of online dating. One third of people who use online dating have never actually gone on a date with someone they met online, a statistic that supports the idea that people browse profiles for fun (Smith). The disclosed method and mobile app presumes that women will talk—at book clubs, in the supermarket, before a meeting—women will talk and dissect the profiles they have seen. The disclosed method and mobile app advertises itself: with every member, a group of the member's friends and advisors, i.e. vetters, joins the app as well. The vetters will spread the buzz, and soon, other women, women who are not actively dating, will start to wish that they, too, had single friends and a chance to play vetter and help their single friends.

Targeted specifically at the 29+ woman who would rather meet someone through a friend than through a computer algorithm, the disclosed method and mobile app mobilizes an untapped demographic: the woman who unexpectedly finds herself on the dating scene in mid-life, but protests that she is “not ready to go there” because she's too busy and it's too “impersonal. She has little to no online footprint, and she is profoundly anxious about meeting someone online, given her knowledge that close to 53% of all people lie in their online profiles (Thottam). One of the major obstacles preventing this woman from online dating is the fact that she believes, as 21% of Americans still do, that “online dating is for desperate people” (Smith). By surrounding this woman with friends who are vetting, the disclosed method and mobile app provides assurance, validation, and control. It removes the stigma from online dating by making it a social activity. This woman doesn't have to do anything; her vetters will do ALL the work.

In order to explain how the disclosed method and dating app works, an example, hypothetical case study of Mary will be used. Behind the book club jokes and her friends' intimate knowledge of her dating history lurks a darker story that speaks to the urgent need for the disclosed method and mobile app: Mary's female friends feel responsible for her abusive marriage. Fifteen years ago, shortly after she first met her now ex-husband on Match.com, they staged an intervention. They were all younger then: six women in their mid-thirties. A doctor. A lawyer. A college professor. When Mary told them she was engaged, they scheduled a dinner. She thought it was going to be a raucous congratulatory celebration, like the ones they had had for other engagements. It was not. It was a full-on intervention. “We're worried,” they told Mary. “We don't think you should marry him,” they protested. “His behavior isn't normal,” they argued.

But Mary didn't listen.

If only they had been able to thwart Mary from seeing his profile that very first time she pulled it up on Match.com. If only she had had the disclosed method and mobile app.

The profile of the disclosed method and mobile app is created by the client filling out a one-page profile which lists education, location, age, and a series of questions. In keeping with he disclosed method and mobile app's focus on narrative—on the stories we share between friends and families—this profile will have clients respond in their own words and images to a discrete number of serious and light-hearted questions.

The disclosed method and mobile app profile stands apart from other dating questionnaires because it is a group effort. The key tenet of the disclosed method and mobile app is “Friends Make Dating Better.” To this end, a client's vetters have a distinct presence in your profile with several questions asked from their perspective. Not only does this capitalize on the social aspect of online dating, but it gives the potential date the added benefit of another perspective. The vetters, in short, provide a dual function: they are vetting both candidate and client.

The disclosed method and mobile app profile also distinguishes itself because of its multi-media potential. Clients will have the option to add a photograph (for example, not more than 5 years old with a notation of who took it), video, or soundtrack to each answer, which will add depth and a potential sense of humor to the profile. The profile offers clients a more personal experience than the “swipe left” dating applications.

For example, Mary's profile may look something like below.

Name: Mary

Education: BA, English, Davidson College 1993

Places I have lived: Houston, Raleigh, Palo Alto, St Louis, Atlanta, Chicago, Philadelphia.

Where I live now: Just outside Philadelphia.

How far away is too far for your partner to live? 35 miles

If my friends had to agree on three words to describe me, they would be: determined, athletic, super-smart

Worst job ever: Assistant to an 80-year-old with a colostomy bag, the evidence of which I occasionally had to clean up.

Best job ever: Working archaeological excavations in Eastern Europe.

In another life, I would be . . . Running the Laugavegur Ultramarathon in Iceland, then driving around the country for a week.

Where do you and your friends hang out? Forbidden Drive and wherever there are long hills to mimic the Boston Marathon course

What I do now: Communications and meeting planning for Big Pharma.

Last nice thing I did for someone else: Hosted a playdate for my daughter immediately after a school overnight camping trip.

The last thing I made with my hands: Patio furniture.

In an ideal world, my next vacation would be . . . Running the Laugavegur Ultramarathon in Iceland, then driving around the country for a week.

I make time for . . . My daughter. Running. Sleep.

The last time I wore a costume: Philadelphia Distance Run. I was Princess Leia

Pet of choice? Dogs. Senior dogs.

Dating deal-breakers: Smoking. Narrow-mindedness. Intolerance.

Fervent Catholicism. Pronounced love of the Jersey shore, Will Farrell movies, Coors Light. Poor grammar. Absence of reading. Fear of adventure.

When someone says, “Let's go exercise,” I . . . Can be ready in 5. As long as it isn't Cross-fit.

If my friends were treating me to dinner, they would . . . Make a huge salad, buy tequila and a chocolate cake as appetizers.

Previously married: Yep.

Kids: Nine-year-old daughter, love of my life.

Other Languages: Functional French, familiarity with German and Russian.

First concert attended: Power Station—because my parents wouldn't let me see Duran Duran a few years earlier.

Last concert attended: Father John Misty.

I'd love to have season tickets to . . . The Wilma and the Philadelphia Orchestra.

What do your friends know about you that you wouldn't tell someone on a first date? She can rock a karaoke bar.

You can find the following on my bedside table or in my bedside drawer: Kindle. Whatever I'm reading, on top of a stack of 7 other books I'm absolutely going to get around to reading. Lip balm. Phone. Small plastic toys belonging to my daughter. Dust.

Describe your perfect Sunday morning: Wake up at 8:30. Consume coffee. Consume coffee. Exercise outdoors for 1-3 hours—run, bike, kayak, stand-up paddleboard, ski, etc. as appropriate and available. Have a large and delicious meal.

Equipped with the knowledge that we, as humans, learn from our mistakes and those of our friends, the disclosed method and mobile app process follows the profile with the creation of the filters. Each vetter creates a filtering list of key words that will automatically result in a potential date getting “spun” out of the app database so that they cannot appear on the client's screen. In other words, each vetter filter removes candidates from being seen by the client (i.e. the vetters friend). Once a candidate is spun, his profile becomes unviewable to the client; he is retired, and his profile is now only accessible to the vetters.

The client and her vetter create her word filter and visual screen together, with all words going into a pull-down glossary that other clients can access if they are struggling to create their own filters. Words meant to weed out and attract candidates will be assigned positive and negative values so that, in the case below, the Ironman Triathlete is NOT paired with the recreational jogger.

Using Mary as a case study, the positive and negative filters shown below in Table 1 could be used.

| Positive Word Filter | Negative Word Filter |
|---|---|
| Ironman triathlete | Jogger, CrossFit, car racing |
| Travel | New Jersey, Jersey Shore |
| Film, movies, theatre | Will Ferrell |
| Editor, grammar, literature | Emoticons, emojis, slang |
| Episcopalian, liberal, feminist | Catholic, MAGA |
| Pets, dogs | Cats |
| Coffee | Beer, liquor |

In addition to the word filters described above with reference to Table 1, Photo Filters may be used. For example, no car selfies, no pictures with fish or hunting trophies, no guns, no pictures holding an alcoholic beverage or smoking, no shirtless or tank-top pictures, no “professional” pictures (e.g. in a lab-coat or scrubs), no pictures with children.

Since the disclosed method and mobile app operates as a dual filter and selection process, the vetter will also create the positive filters aimed at catching the most unique of members for their friend. In one embodiment, as counterpoints to the word and photo filters, the group (i.e. the client and their vetters) creates a Wildflower Mix, a list of highly desirable and individualized words aimed at selecting the appealing candidates and a written description of the “wish photograph”:

For Mary, she and her vetters collaboratively create a Wildflower Mix including the following attributes: Boston Marathon, Ironman, Nabokov, and the Oxford Comma. Additionally, Mary's collaborative Wish Photograph is described as follows: A man sitting of the deck of his large and well-maintained house, reading Pale Fire, wearing a Boston Marathon shirt, drinking a cup of coffee, with a full head of hair and a couple of dogs.

The disclosed method and mobile app stands apart in the dating marketspace by empowering a vetter to communicate and ask questions of a potential date. It is an established fact that profiles are passed around informally between friends, and some apps enable you to forward a specific profile to a friend for review. The disclosed method and mobile app differentiates itself as an app by making this passive approach active and by having a group of people join the dating app together as vetters, who can interact with potential dates on behalf of their friend, aka the client.

One of the benefits of the disclosed method and mobile app process is that it takes the work off the shoulders of the clients and potential dating candidates by making it the job of the vetter to establish first contact: to reach out to each potential dating candidate that passes the filtering process to inquire about clarifications or to ask a question, and then the vetter may make an introduction of the candidate to the client. If vetter likes the candidate, the vetter may place the candidate in the clients “vet box” so that the client can decide whether or not to proceed. At this point in the process, the candidate will also be able to view the client's profile and decide if s/he wants to continue. Once the vetter successfully matches two people, and icon may appear on their screens, associated with either the candidate or the client, and they will both be free to communicate with each other.

The extremely trepidatious candidate will be able to chose between mediated and unmediated contact at this point. Should she wish, her vetter will be enabled to view all her correspondence with the candidate and to halt the process or intervene if it appears that the communication is not going well or appropriately.

In one embodiment, at any point, the candidates may search the client database on their own and make contact via messaging, but these contacts will not have the benefit of being vetted, and the above mentioned icon or indicator indicating vetting will not be present or associated with these communications or profiles appearing in this manner. If the client finds a candidate she wants to be vetted, she may forward the profile to her vetters for review.

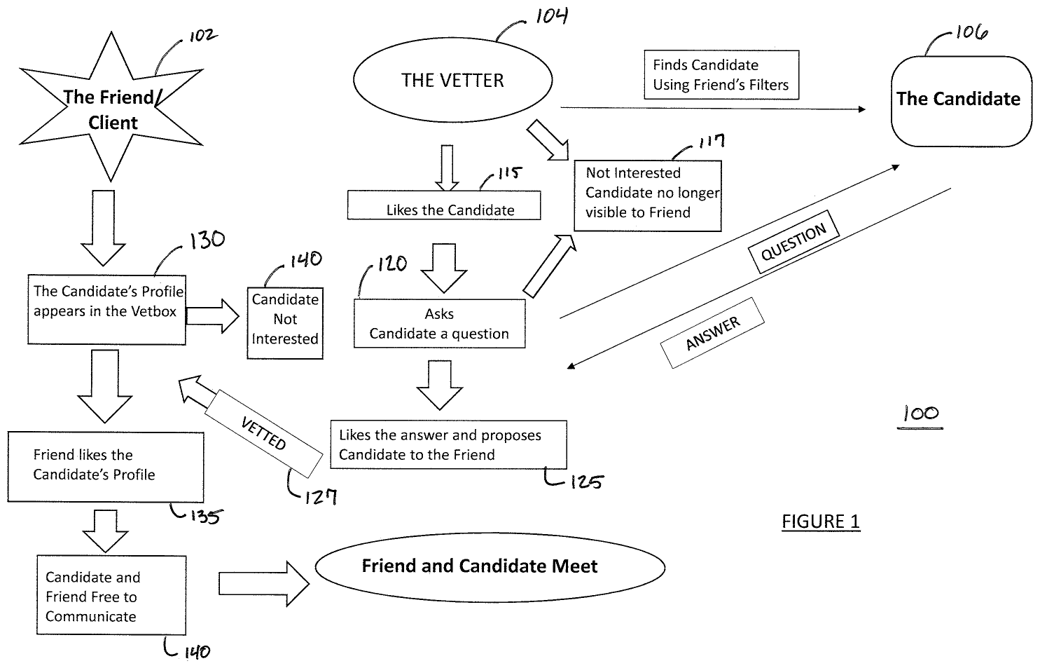

In order to better understand the mechanics of the disclosed dating method and mobile app, reference is now made to FIG. 1, which is a flow diagram 100 of the vetter process described above. There are three people shown in FIG. 1, the friend/client 102, the vetter 104, and the candidate 106. The friend/client 102 is typically the main user of the dating application, i.e. the person looking for a date. The friend/client 102 is friends with the vetter 104. The candidate 106 is a person also on the disclosed method and mobile app system and is also looking for dates.

The method and mobile app flow starts when, after the candidate's 106 profile passes a filter process as described above, the candidate's 106 profile appears in the vetter's 104 feed (step 110). The vetter 104 can review the candidates 106 profile and pictures, and knowing their friend/client 102, can select the candidate or not as a good dating match for the friend/client 102 (step 115). The selection may be similar to many current dating apps like Tinder or Bumble where a potential date's picture and profile appear. The vetter 104 can select the candidate 106 or not after reviewing the candidate's profile and pictures by a left/right swipe on a mobile device, or via some other selection scheme, like clicking select on a GUI. In the case the vetter 104 does not like the candidate 106, the candidate 106 will be hidden from the friend/client 102 (step 117).

If the vetter selects the candidate (i.e. likes the candidate at step 115), the vetter 104 may communicate with the candidate (step 120). In this communication process, the candidate 106 may be made aware of the friend/client 102, and have an opportunity to review the friend/client's 102 profile, while communicating with the vetter 104. In this way, the candidate 106 may determine whether they wish to communicate with the vetter 104 about the friend/client 102. For example, if the candidate 106 has no interest in the friend/client 102, the candidate 106 can choose to not communicate with the vetter 104.

At any point during the conversation with the candidate 106, the vetter 104 may determine that the candidate 104 is good match for the friend/client 102 (step 125). If the vetter 104 determines that the candidate 106 is a good match for the friend/client 102, the vetter 104 may select the candidate's 106 profile as “vetted” (step 127). If the vetter 104 determines the candidate 106 is not a good match for the friend/client 102, the vetter 104 can discard the candidate's 106 profile (step 117, again). If the vetter 104 determines the candidate 106 is vetted (step 127), then the candidate's 106 profile becomes visible to the friend/client 102 (step 130). The vetter 104 may offer an introduction, but this is likely not necessary as chances are the vetter 104 and the friend/client 102 are already discussing the candidate 106, particularly if a match seems likely.

Once the vetter 104 has determined that the candidate 106 is vetted, the friend/client 102 can now see the candidate's 106 profile in their feed, also called the vetbox (step 130). The friend/client 102 can then select the candidate 106 by swiping right/left or by other methods known to those skilled in the dating app art (step 135), in a similar manner to how the vetter 104 selected the candidate's 106 profile. The vetter 104 may include commentary associated with the candidate's 106 profile at step 127. When the friend/client 102 is reviewing profiles, it may be possible to mix in vetted profiles and non-vetted profiles. In such a situation, the vetted profiles are easily identifiable with a badge/icon or some other indication to alert the friend/client 102 to the fact that the profile being viewed is a vetted profile. In addition to, or in place of, the vetter's 104 commentary on a vetted candidate profile, in some situations the vetter 104 may also include the dialogue that occurred between the vetter 104 and the candidate 106. The friend/client 102 can then review that material and consider that information in determining whether to select the candidate's 106 profile. Once the friend/client 102 selects a vetted candidate's profile, the friend/client 102 and the candidate 106 can then converse in a chat window (step 140).

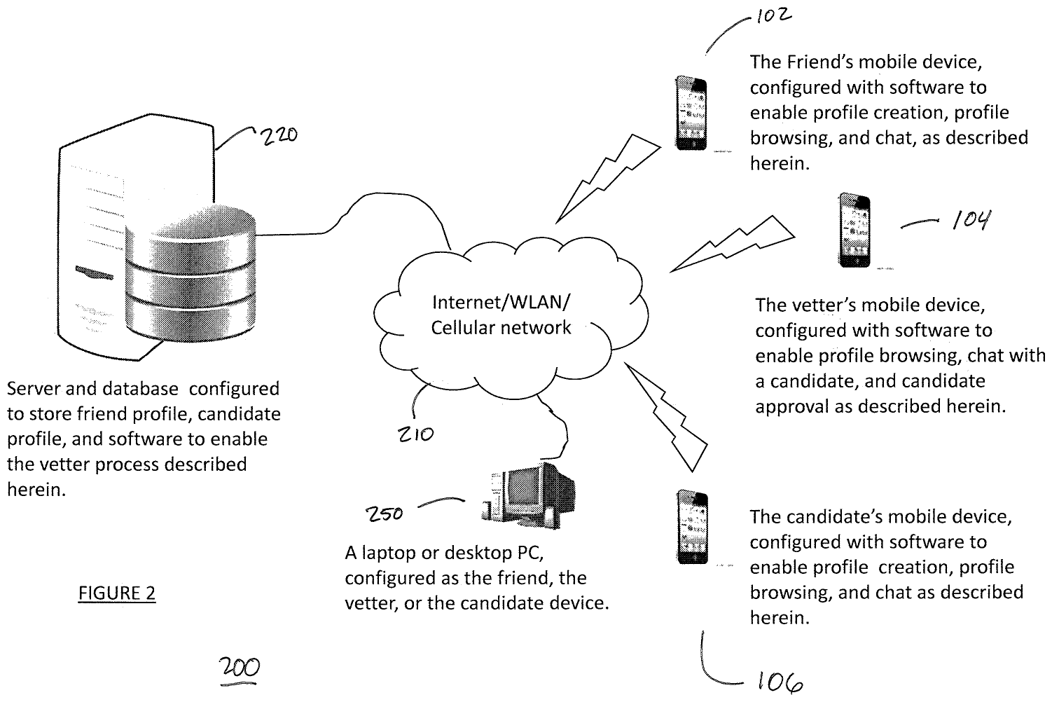

FIG. 2 shows a computer system 200 for implementing the above described embodiments. Each of the candidate 106, the friend/client 102, and the vetter 104 have a mobile device with a software application running thereon. The invention is not limited to mobile devices however and similar software may also be operable on a laptop or desktop computer 250, or any web browser. The devices communicate through the internet 210 to a server and storage 220. The above described profiles may be stored in the storage and retrieved by the software applications running on the mobile devices 102, 104, 106 or laptop/desktop 250. In one embodiment, the software application running on the mobile devices 102, 104, 106 may be an iOS or Android compatible software application.

The above description references several works including the following: Slotter Erica B. “Why Your Friends' Approval is So Crucial to a Relationship.” Psychology Today 13 Mar. 2015: 1-5, Smith, Aaron, and Monica Anderson. “5 Facts About Online Dating.” Pew Research Center. www.pewresearch.org. 29 Feb. 2016, Thottam, Isabel. “10 Online Dating Statistics You Should Know.” www.eharmonv.com. 2018, and Winkler, Elizabeth. “Room for 2 in Date Game.” WSJ 14 May 2018.

What is claimed is:

1. A non-transitory computer readable storage medium storing a set of instructions for execution on a mobile device to enable a dating application, the set of instructions causing the mobile device to:
display a profile of a dating candidate that satisfies criteria defined by a friend of a user of the mobile device;
receive input from the user of the mobile device to select or not select the profile of the dating candidate;
on a condition that the user of the mobile device selects the profile of the dating candidate, enabling text communication by the user of the mobile device and the dating candidate;
receive input from the user of the mobile device indicating approval of the dating candidate for the friend of the user of the mobile device based on the text communication by the user of the mobile device and the dating candidate;
transmitting a message to an application server, via the Internet, indicating approval of the dating candidate for the friend of the user of the mobile device to enable direct communication between the dating candidate and the friend of the user of the mobile device.
